(19) United States
(12) Patent Application Publication
(10) Pub. No.: US 2012/0172502 A1
(43) Pub. Date: Jul. 5, 2012

(54) Flame Retardant Thermoplastic Resin Composition

(75) Inventors: Woo Kyun Lee, Yeosu-si (KR); Bang Duk Kim, Yeosu-si (KR); Chang Do Jung, Uiwang-si (KR); Sung Hun Jin, Yeosu-si (KR)

(73) Assignee: CHEIL INDUSTRIES INC., Gumi-si (KR)

(21) Appl. No.: 13/332,755

(22) Filed: Dec. 21, 2011

(30) Foreign Application Priority Data
Dec. 29, 2010 (KR) 10-2010-0137515

(51) Int. Cl. C08L 51/04; C08L 25/12; C08L 25/02; C08L 25/06; C08K 5/1515; C08K 13/02

(52) U.S. Cl. 524/114

(57) ABSTRACT

A flame retardant thermoplastic resin composition according to the present invention comprises (A) about 100 parts by weight of rubber modified aromatic vinyl copolymer resin; (B) about 0.1 parts by weight to about 10 parts by weight of a matting agent, based on about 100 parts by weight of the rubber modified aromatic vinyl copolymer resin (A); and (C) about 19 parts by weight to about 23 parts by weight of a brominated flame retardant, based on about 100 parts by weight of the rubber modified aromatic vinyl copolymer resin (A). The composition can have excellent impact strength and low-gloss property.

### CROSS-REFERENCE TO RELATED APPLICATION

This application claims priority under 35 USC Section 119 to and the benefit of Korea Patent Application No. 10-2010-0137515, filed on Dec. 29, 2011, in the Korean Intellectual Property Office, the disclosure of which is incorporated herein by reference in its entirety.

### FIELD OF THE INVENTION

The present invention relates to a flame retardant thermoplastic resin composition

### BACKGROUND OF THE INVENTION

Styrene-acrylonitrile-butadiene (ABS) copolymer resin is prepared from styrene, which can have excellent processability, acrylonitrile, which can have excellent strength and chemical resistance, and butadiene, which can have excellent impact resistance. Because ABS resin has these various properties, it has been used for various applications such as automobiles, electrical/electronic devices, office equipments, home appliances, toys and the like.

ABS resins can also be used in applications requiring flame retardancy such as wiring ducts. Increasing the amount of butadiene can increase impact resistance but can also deteriorate flame retardancy. Thus, there is a need for a material that is flame retardant yet also can maintain a certain level of impact resistance.

Also, because wiring ducts are often installed in interior spaces, there is an increasing preference for wiring ducts with a low-gloss appearance instead of a high-gloss appearance. There is also an increasing preference for low-gloss exterior and interior materials for automobiles, home appliances, and the like.

Conventionally injection molded products are surface coated to impart a low-gloss appearance. In this manner, light can be scattered by roughening the surface of a molded article to decrease surface gloss. Surface gloss can also be decreased without a coating process by increasing the rubber size of the thermoplastic resin bigger or by adding a talc-based additive. However, these methods may not decrease surface gloss below a certain level. Also these methods can deteriorate other properties of the article such as impact resistance.

### SUMMARY OF THE INVENTION

In order to solve the above problems, the present inventors have developed a flame retardant thermoplastic resin composition that can have excellent low-gloss property and impact resistance by adding a certain amount of a matting agent and a brominated flame retardant to a rubber modified aromatic vinyl copolymer resin. The thermoplastic resin composition can also have excellent flame retardancy.

A flame retardant thermoplastic resin composition according to the present invention comprises (A) about 100 parts by weight of rubber modified aromatic vinyl copolymer resin; (B) about 0.1 parts by weight to about 10 parts by weight of a matting agent, based on about 100 parts by weight of the rubber modified aromatic vinyl copolymer resin (A); and (C) about 19 parts by weight to about 23 parts by weight of a brominated flame retardant, based on about 100 parts by weight of the rubber modified aromatic vinyl copolymer resin (A).

In exemplary embodiments of the present invention, the rubber modified aromatic vinyl copolymer resin (A) comprises (A1) about 21% by weight to about 34% by weight of a graft copolymer resin prepared by graft-copolymerizing rubbery polymer, aromatic vinyl monomer, monomer copolymerizable with aromatic vinyl monomer and optionally monomer imparting processability and heat resistance, and (A2) about 66% by weight to about 79% by weight of a copolymer resin prepared by copolymerizing aromatic vinyl monomer, monomer copolymerizable with aromatic vinyl monomer and optionally monomer imparting processability and heat resistance.

In exemplary embodiments of the present invention, the graft copolymer (A1) is prepared by graft-copolymerizing about 34% by weight to about 94% by weight of the aromatic vinyl monomer, about 1% by weight to about 30% by weight of the monomer copolymerizable with aromatic vinyl monomer and about 0% by weight to about 15% by weight of the monomer imparting processability and heat resistance onto about 5% by weight to about 65% by weight of the rubbery polymer.

In exemplary embodiments of the present invention, the copolymer resin (A2) is prepared by copolymerizing about 60% by weight to about 90% by weight of the aromatic vinyl monomer, about 10% by weight to about 40% by weight of the monomer copolymerizable with aromatic vinyl monomer and about 0% by weight to about 30% by weight of the monomer imparting processability and heat resistance.

In exemplary embodiments of the present invention, the matting agent (B) can have a weight average molecular weight of about 1,000,000 g/mol to about 10,000,000 g/mol.

In exemplary embodiments of the present invention, the matting agent (B) comprises a mixture of polystyrene and acrylonitrile-styrene copolymer.

In exemplary embodiments of the present invention, the brominated flame retardant (C) comprises brominated epoxy oligomer.

In exemplary embodiments of the present invention, the flame retardant thermoplastic resin composition further comprises antimony oxide as a flame retardant aid.

In exemplary embodiments of the present invention, the flame retardant thermoplastic resin composition further comprises one or more additives selected from the group consisting of plasticizers, anti-dropping agents, heat stabilizers, release agents, weather-proof stabilizers, halogen stabilizers, lubricants, fillers, coupling agents, light stabilizers, antioxidants, coloring agents, anti-static agents, dispersing agents, impact modifiers, and combinations thereof.

In exemplary embodiments of the present invention, a specimen with a thickness of 3.175 mm formed of the flame retardant thermoplastic resin composition can have a notch izod impact strength measured in accordance with ASTM D256 of about 10 kgf·cm/cm to about 20 kgf·cm/cm.

In exemplary embodiments of the present invention, the flame retardant thermoplastic resin composition can have a melt flow index measured in accordance with ASTM D1238 under the conditions of a temperature of 200° C. and a load of 5 kg of about 2.3 g/10 min to about 3.0 g/10 min.

In exemplary embodiments of the present invention, a specimen with a thickness of 2.5 mm formed of the flame retardant thermoplastic resin composition can have a flame retardant level measured in accordance with UL94 of V0.

In exemplary embodiments of the present invention, a specimen prepared by injection-molding the flame retardant thermoplastic resin composition by means of a color chip G30 face injection machine can have a degree of gloss measured in accordance with ASTM D523 in a vertical direction at 60 degrees of about 10 to about 25.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A flame retardant thermoplastic resin composition according to the present invention comprises (A) about 100 parts by weight of rubber modified aromatic vinyl copolymer resin; (B) about 0.1 parts by weight to about 10 parts by weight of a matting agent, based on about 100 parts by weight of the rubber modified aromatic vinyl copolymer resin (A); and (C) about 19 parts by weight to about 23 parts by weight of a brominated flame retardant, based on about 100 parts by weight of the rubber modified aromatic vinyl copolymer resin (A).

(A) Rubber Modified Aromatic Vinyl Copolymer Resin

The rubber modified aromatic vinyl copolymer resin is prepared by polymerizing aromatic vinyl monomer, monomer copolymerizable with aromatic vinyl monomer, and optionally monomer imparting processability and heat resistance, with a rubbery polymer.

The rubber modified aromatic vinyl copolymer resin can comprise only the graft copolymer resin. Alternatively, the rubber modified aromatic vinyl copolymer resin can comprise both the graft copolymer resin and a non-grafted copolymer resin. When the rubber modified aromatic vinyl copolymer resin comprise both the graft copolymer resin and non-grafted copolymer resin, the amount of the monomers used can be adjusted based on the compatibility.

In exemplary embodiments of the present invention, the rubber modified aromatic vinyl copolymer resin (A) comprises (A1) about 21% by weight to about 34% by weight of a graft copolymer resin prepared by graft-copolymerizing rubbery polymer, aromatic vinyl monomer, monomer copolymerizable with aromatic vinyl monomer and optionally monomer imparting processability and heat resistance, and (A2) about 66% by weight to about 79% by weight of a copolymer resin prepared by copolymerizing aromatic vinyl monomer, monomer copolymerizable with aromatic vinyl monomer and optionally monomer imparting processability and heat resistance.

In some embodiments, the rubber modified aromatic vinyl copolymer resin (A) can include the (A1) graft copolymer resin in an amount of about 21, 22, 23, 24, 25, 26, 27, 28, 29, 30, 31, 32, 33, or 34% by weight. Further, according to some embodiments of the present invention, the amount of the graft copolymer resin can be in a range from about any of the foregoing amounts to about any other of the foregoing amounts.

In some embodiments, the rubber modified aromatic vinyl copolymer resin (A) can include the (A2) copolymer resin in an amount of about 66, 67, 68, 69, 70, 71, 72, 73, 74, 75, 76, 77, 78, or 79% by weight. Further, according to some embodiments of the present invention, the amount of the copolymer resin can be in a range from about any of the foregoing amounts to about any other of the foregoing amounts.

For example, the rubber modified aromatic vinyl copolymer resin (A) can comprise the graft copolymer resin (A1) in an amount of about 25% by weight or about 30% by weight. Also, the rubber modified aromatic vinyl copolymer resin (A) can comprise the copolymer resin (A2) in an amount of about 70% by weight or about 75% by weight. In this case, the graft copolymer resin (A1) is dispersed in the form of particles in a matrix (the continuous phase) including the copolymer resin (A2).

(A1) Graft Copolymer Resin

The graft copolymer resin is prepared by graft-copolymerizing aromatic vinyl monomer, monomer copolymerizable with aromatic vinyl monomer, and optionally monomer imparting processability and heat resistance, onto rubbery polymer.

Examples of the rubbery polymer include without limitation diene-based rubbers such as polybutadiene, polyisoprene, poly(styrene-butadiene), poly(acrylonitrile-butadiene) and the like, saturated rubbers prepared by adding hydrogen to the diene-based rubber, acrylic-based rubbers such as polybutylacrylic acid and the like, ethylene-propylene-diene monomer rubbers, and the like, and combinations thereof. In exemplary embodiments, the rubbery polymer can be a diene-based rubber, such as a butadiene-based rubber.

The rubbery polymer can be used in an amount of about 5% by weight to about 65% by weight, based on about 100% by weight of the rubbery polymer and mixture of graft-copolymerizable monomers. In some embodiments, the rubbery polymer can be used in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65% by weight. Further, according to some embodiments of the present invention, the amount of the rubbery polymer can be in a range from about any of the foregoing amounts to about any other of the foregoing amounts. For example, the rubbery polymer can be used in an amount of about 50% by weight, based on about 100% by weight of the rubbery polymer and mixture of graft-copolymerizable monomers.

The average particle diameter of the rubbery polymer can be about 0.1 μm to about 4 μm, taking into consideration impact resistance and appearance. In an exemplary embodiment of the present invention, the average particle diameter of the rubbery polymer can be about 0.26 μm to about 0.30 μm. For example, the average particle diameter of the rubbery polymer can be about 0.28 μm.

Examples of the aromatic vinyl monomer include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene and the like, and combinations thereof. In exemplary embodiments, styrene can be used.

The aromatic vinyl monomer can be used in an amount of about 34% by weight to about 94% by weight, based on about 100% by weight of the rubbery polymer and mixture of graft-copolymerizable monomers. In some embodiments, the aromatic vinyl monomer can be used in an amount of about 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94% by weight. Further, according to some embodiments of the present invention, the amount of the aromatic vinyl monomer can be in a range from about any of the foregoing amounts to about any other of the foregoing amounts. For example, the aromatic vinyl monomer can be used in an amount of about 36% by weight, based on about 100% by weight of the rubbery polymer and mixture of graft-copolymerizable monomers.

In exemplary embodiments of the present invention, one or more of monomers copolymerizable with aromatic vinyl monomer can be introduced in the graft copolymer resin (A1). Examples of the introducible monomer include without limitation vinyl cyanides such as acrylonitrile, unsaturated nitrile-based compounds such as ethacrylonitrile or methacrylonitrile, and the like, and combinations thereof.

The monomer copolymerizable with aromatic vinyl monomer can be used in an amount of about 1% by weight to about 30% by weight, based on about 100% by weight of the rubbery polymer and mixture of graft-copolymerizable monomers. In some embodiments, the monomer copolymerizable with aromatic vinyl monomer can be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the monomer copolymerizable with aromatic vinyl monomer can be in a range from about any of the foregoing amounts to about any other of the foregoing amounts. For example, the monomer copolymerizable with aromatic vinyl monomer can be used in an amount of about 14% by weight, based on about 100% by weight of the rubbery polymer and mixture of graft-copolymerizable monomers.

Examples of the monomer imparting processability and heat resistance include without limitation acrylic acid, methacrylic acid, maleic anhydride, N-substituted maleimide and the like, and combinations thereof.

The monomer imparting processability and heat resistance can be used in an amount of about 0% by weight to about 15% by weight, based on about 100% by weight of the rubbery polymer and mixture of graft-copolymerizable monomers. In some embodiments, the monomer imparting processability and heat resistance can be used in an amount of zero % by weight (the monomer is not present), or about 0 (the monomer is present) 1, 2, 3, 4, 5, 6, 7, 8, 9, 10, 11, 12, 13, 14, or 15% by weight. Further, according to some embodiments of the present invention, the amount of the monomer imparting processability and heat resistance can be in a range from about any of the foregoing amounts to about any other of the foregoing amounts.

In exemplary embodiments of the present invention, the graft copolymer resin comprises polybutadiene (PBD) in an amount of about 54% by weight to about 62% by weight. In some embodiments, the graft copolymer resin comprises polybutadiene (PBD) in an amount of about 54, 55, 56, 57, 58, 59, 60, 61, or 62% by weight. Further, according to some embodiments of the present invention, the amount of polybutadiene can be in a range from about any of the foregoing amounts to about any other of the foregoing amounts. For example, the graft copolymer resin can include polybutadiene (PBD) in an amount of about 58% by weight.

In exemplary embodiments of the present invention, the graft copolymer resin can have a degree of grafting of the rubber polymer of about 70% to about 95%. In some embodiments, the degree of grafting of the rubber polymer can range from about 70, 71, 72, 73, 74, 75, 76, 77, 78, 79, 80, 81, 82, 83, 84, 85, 86, 87, 88, 89, 90, 91, 92, 93, 94, or 95%. Further, according to some embodiments of the present invention, the degree of grafting of the rubber polymer can be in a range from about any of the foregoing amounts to about any other of the foregoing amounts. For example, the graft copolymer resin can have a degree of grafting of about 89%.

(A2) Copolymer Resin

The copolymer resin (A2) is prepared by copolymerizing aromatic vinyl monomer, monomer copolymerizable with aromatic vinyl monomer, and optionally monomer imparting processability and heat resistance. The amount of the monomers used for preparation of the graft copolymer resin and amount of the monomers used for preparation of the copolymer resin can be adjusted, taking into consideration compatibility.

Examples of the aromatic vinyl monomer include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene and the like, and combinations thereof. In exemplary embodiments, styrene can be used.

The aromatic vinyl monomer can be used in an amount of about 60% by weight to about 90% by weight, based on about 100% by weight of mixture of monomers. In some embodiments, the aromatic vinyl monomer can be used in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of the aromatic vinyl monomer can be in a range from about any of the foregoing amounts to about any other of the foregoing amounts. For example, the aromatic vinyl monomer can be used in an amount of about 75% by weight, based on about 100% by weight of mixture of monomers.

Examples of the monomer copolymerizable with aromatic vinyl monomer include without limitation vinyl cyanides such as acrylonitrile, unsaturated nitrile-based compounds such as ethacrylonitrile and methacrylonitrile, and the like, and combinations thereof.

The monomer copolymerizable with aromatic vinyl monomer can be used in amount of about 10% by weight to about 40% by weight, based on about 100% by weight of the mixture of monomers. In some embodiments, the monomer copolymerizable with aromatic vinyl monomer can be used in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the amount of the monomer copolymerizable with aromatic vinyl monomer can be in a range from about any of the foregoing amounts to about any other of the foregoing amounts. For example, the monomer copolymerizable with aromatic vinyl monomer can be used in an amount of about 25% by weight, based on about 100% by weight of the mixture of monomers.

Examples of the monomer imparting processability and heat resistance include without limitation acrylic acid, methacrylic acid, maleic anhydride, N-substituted maleimide and the like, and combinations thereof.

The monomer imparting processability and heat resistance can be used in an amount of about 0% by weight to about 30% by weight, based on about 100% by weight of the mixture of monomers. In some embodiments, the monomer imparting processability and heat resistance can be used in an amount of zero % by weight (the monomer is not present), or about 0 (the monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the monomer copolymerizable with aromatic vinyl monomer can be in a range from about any of the foregoing amounts to about any other of the foregoing amounts.

Examples of the rubber modified aromatic vinyl copolymer resin (A) include without limitation acrylonitrile-butadiene-styrene copolymer resin (ABS resin), acrylonitrile-ethylenepropylene rubber-styrene copolymer resin (AES resin), acrylonitrile-acrylic rubber-styrene copolymer resin (AAS resin) and the like, and combinations thereof.

(B) Matting Agent

The matting agent affects the surface of a molded article to make the surface of a molded article rough, to scatter light on the surface of a molded article, and to thereby impart non-gloss property to a thermoplastic resin. In the present invention, by adding the matting agent, not only properties of the thermoplastic resin composition before the matting agent is added can be maintained but also the surface gloss of the molded article can be highly decreased.

In exemplary embodiments of the present invention, the matting agent has an ultra-high molecular weight. For example, the matting agent can have a weight average molecular weight of about 1,000,000 g/mol to about 10,000,000 g/mol, for example about 2,000,000 g/mol to about 8,000,000 g/mol. When the weight average molecular weight of the matting agent is less than about 1,000,000 g/mol, a gloss decreasing effect may not appear.

In exemplary embodiments of the present invention, the matting agent (B) comprises a mixture of polystyrene and acrylonitrile-styrene copolymer. Also, in exemplary embodiments of the present invention, the matting agent (B) comprises a mixture of styrene-based matrix and crosslinked acrylonitrile-styrene copolymer.

Mixtures of polystyrene and acrylonitrile-styrene copolymer, including a styrene-based matrix and crosslinked acrylonitrile-styrene copolymer, are known to the skilled artisan and are commercially available.

In exemplary embodiments, the matting agent can include a mixture of polystyrene and acrylonitrile-styrene copolymer, wherein the mixture can include polystyrene in an amount of about 20 to about 30% by weight and acrylonitrile-styrene copolymer in an amount of about 70 to about 80% by weight. Further, the acrylonitrile-styrene copolymer can include acrylonitrile in an amount of about 70 to about 80% by weight, and styrene in an amount of about 20 to about 30% by weight.

In some embodiments, the mixture of polystyrene and acrylonitrile-styrene copolymer can include polystyrene in an amount of about 20, 21, 22, 23, 24, 25, 26, 27, 28, 29, or 30% by weight. Further, according to some embodiments of the present invention, the amount of polystyrene can be in a range from about any of the foregoing amounts to about any other of the foregoing amounts.

In some embodiments, the mixture of polystyrene and acrylonitrile-styrene copolymer can include acrylonitrile-styrene copolymer in an amount of about 70, 71, 72, 73, 74, 75, 76, 77, 78, 79, or 80% by weight. Further, according to some embodiments of the present invention, the amount of acrylonitrile-styrene copolymer can be in a range from about any of the foregoing amounts to about any other of the foregoing amounts.

In some embodiments, the acrylonitrile-styrene copolymer can include acrylonitrile in an amount of about 70, 71, 72, 73, 74, 75, 76, 77, 78, 79, or 80% by weight. Further, according to some embodiments of the present invention, the amount of acrylonitrile in the acrylonitrile-styrene copolymer can be in a range from about any of the foregoing amounts to about any other of the foregoing amounts.

In some embodiments, the acrylonitrile-styrene copolymer can include styrene in an amount of about 20, 21, 22, 23, 24, 25, 26, 27, 28, 29, or 30% by weight. Further, according to some embodiments of the present invention, the amount of styrene in the acrylonitrile-styrene copolymer can be in a range from about any of the foregoing amounts to about any other of the foregoing amounts.

In the present invention, the composition can include the matting agent in an amount of about 0.1 parts by weight to about 10 parts by weight, for example about 2 parts by weight to about 6 parts by weight, and as another example about 4 parts by weight to about 6 parts by weight, based on about 100 parts by weight of the rubber modified aromatic vinyl copolymer resin. In some embodiments, the flame retardant thermoplastic resin composition can include the matting agent in an amount of about 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of the matting agent can be in a range from about any of the foregoing amounts to about any other of the foregoing amounts. For example, the composition can include the matting agent in an amount of about 2 parts by weight, about 4 parts by weight or about 6 parts by weight, based on about 100 parts by weight of the rubber modified aromatic vinyl copolymer resin.

When the flame retardant thermoplastic resin composition includes the matting agent in an amount of more than about 10 parts by weight, flame retardancy may deteriorate.

(C) Brominated Flame Retardant

Examples of the brominated flame retardant include without limitation tetrabromo bisphenol-A, decabromo diphenyloxide, decabrominated diphenylethane, 1,2-bis(tribromophenyl)ethane, brominated epoxy oligomer, octabromo trimethylphenyl indane, bis(2,3-dibromopropyl ether), tris(tribromophenyl)triazine, brominated aliphatic hydrocarbon, brominated aromatic hydrocarbon and the like, and combinations thereof.

In exemplary embodiments of the present invention, the brominated flame retardant (C) comprises a brominated epoxy oligomer. Also, the brominated flame retardant may consist of a brominated epoxy oligomer. In exemplary embodiments of the present invention, the brominated epoxy oligomer can have a weight average molecular weight of about 600 g/mol to about 8,000 g/mol.

In exemplary embodiments of the present invention, the brominated flame retardant can comprise a mixture of brominated diphenylethanes. In exemplary embodiments of the present invention, the mixture of brominated diphenylethanes can comprise hexabromo diphenylethane in an amount of about 55% by weight to about 85% by weight, for example about 57% by weight to about 85% by weight, and as another example about 60% by weight to about 85% by weight. Also, the mixture of brominated diphenylethanes can comprise the hexabromo diphenylethane in an amount of about 65% by weight to about 85% by weight. Also, the mixture of brominated diphenylethane can comprise the hexabromo diphenylethane in an amount of about 70% by weight to about 85% by weight.

In exemplary embodiments of the present invention, the mixture of brominated diphenylethanes can further comprise bromodiphenyl ethanes selected from the group consisting of pentabromo diphenylethane, heptabromo diphenylethane, octabromo diphenylethane, nonabromo diphenylethane, decabromodipehnylethane and combinations thereof.

The mixture of brominated diphenylethanes can comprise hexabromo diphenylethane in an amount of about 55% by weight to about 85% by weight, and thereby can impart excellent weatherproof and heat resistance to the thermoplastic resin composition.

In exemplary embodiments of the present invention, the flame retardant thermoplastic resin composition can include other halogen-based flame retardants, phosphorus-based flame retardants, and the like, and combinations thereof, instead of/as well as the brominated diphenylethane.

In exemplary embodiments of the present invention, the flame retardant thermoplastic resin composition can include the brominated flame retardant in an amount of about 19 parts by weight to about 23 parts by weight, based on about 100 parts by weight of the rubber modified aromatic vinyl copolymer resin. In some embodiments, the flame retardant thermoplastic resin composition can include the brominated flame retardant in an amount of about 19, 20, 21, 22, or 23 parts by weight. Further, according to some embodiments of the present invention, the amount of the brominated flame retardant can be in a range from about any of the foregoing amounts to about any other of the foregoing amounts. For example, the flame retardant thermoplastic resin composition can include the brominated flame retardant in an amount of about 21 parts by weight, based on about 100 parts by weight of the rubber modified aromatic vinyl copolymer resin.

In exemplary embodiments of the present invention, the flame retardant thermoplastic resin composition can further comprise one or more additives such as but not limited to flame retardant aids, plasticizers, anti-dripping agents, heat stabilizers, release agents, weather-proof stabilizers, halogen stabilizers, lubricants, fillers, coupling agents, light stabilizers, antioxidants, coloring agents, anti-static agents, dispersing agents, impact modifiers and the like, as needed. These can be used alone or in combination thereof. For example, the flame retardant thermoplastic resin composition can further comprise a flame retardant aid, primary antioxidant, secondary antioxidant and lubricant.

Examples of the flame retardant aid include without limitation antimony oxide and the like. Examples of the antimony oxide include without limitation antimony trioxide, antimony pentaoxide, and the like, and combinations thereof. In exemplary embodiments, the antimony trioxide can be used. The antimony trioxide can have a 50% particle size of about 0.01 μm to about 6 μm, for example about 0.02 μm to about 3.0 μm. The antimony pentaoxide can have a particle size of about 0.01 μm to about 1.0 μm, for example about 0.02 μm to about 0.5 μm.

In exemplary embodiments of the present invention, the composition can include antimony oxide in an amount of about 1 part by weight to about 6 parts by weight, based on about 100 parts by weight of the rubber modified aromatic vinyl copolymer resin. When the composition includes antimony oxide in an amount of more than about 6 parts by weight, the balance of properties of the resin may be harmed. In exemplary embodiments, the composition may include the antimony oxide in an amount of about 2 parts by weight to about 6 parts by weight, or about 3 parts by weight to about 6 parts by weight. For example, the composition can include antimony oxide in an amount of about 5.5 parts by weight, based on about 100 parts by weight of the rubber modified aromatic vinyl copolymer resin.

In exemplary embodiments of the present invention, a specimen with a thickness of 3.175 mm formed of the flame retardant thermoplastic resin composition can have a notch izod impact strength measured in accordance with ASTM D256 of about 10 kgf·cm/cm to about 20 kgf·cm/cm. For example, the notch izod impact strength of a specimen with a thickness of 3.175 mm formed of the flame retardant thermoplastic resin composition measured in accordance with ASTM D256 can be about 11.5 kgf·cm/cm, about 11.8 kgf·cm/cm, about 12.1 kgf·cm/cm, about 17.4 kgf·cm/cm, about 17.6 kgf·cm/cm or about 18.5 kgf·cm/cm.

In exemplary embodiments of the present invention, the flame retardant thermoplastic resin composition can have a melt flow index measured in accordance with ASTM D1238 under the conditions of a temperature of 200° C. and a load of 5 kg of about 2.3 g/10 min to about 3.0 g/10 min. For example, the melt flow index of the flame retardant thermoplastic resin composition measured in accordance with ASTM D1238 under the conditions of a temperature of 200° C. and a load of 5 kg can be about 2.4 g/10 min, about 2.5 g/10 min, about 2.7 g/10 min or about 2.8 g/10 min.

In exemplary embodiments of the present invention, a specimen with thickness of 2.5 mm formed of the flame retardant thermoplastic resin composition can have a flame retardant level measured in accordance with UL94 of V0.

In exemplary embodiments of the present invention, a specimen, which is prepared by injection-molding the flame retardant thermoplastic resin composition by means of color chip G30 face injection machine can have a gloss degree measured in accordance with ASTM D523 in a vertical direction at 60 degrees of about 10 to about 25. For example, the gloss degree of a specimen prepared by injection-molding the flame retardant thermoplastic resin composition by means of color chip G30 face injection machine measured in accordance with ASTM D523 in a vertical direction at 60 degrees can be about 16, about 17, about 19, about 20, about 23 or about 24.

The invention may be better understood by reference to the following examples which are intended for the purpose of illustration and are not to be construed as in any way limiting the scope of the present invention, which is defined in the claims appended hereto.

### EXAMPLES

Specifications of each component used in the following examples and comparative examples are as follows.

(A) Rubber Modified Aromatic Vinyl Copolymer Resin

(A1) Graft Copolymer Resin

50 parts by weight of solid content of butadiene rubber latex, 36 parts by weight of styrene, 14 parts by weight of acrylonitrile, 150 parts by weight of deionized water, 1.0 part by weight of potassium oleate, 0.4 parts by weight of cumenehydroperoxide, 0.2 parts by weight of t-dodecyl mercaptan, 0.4 parts by weight of glucose, 0.01 parts by weight of iron sulfate hydrate, and 0.3 parts by weight of sodium pyrophosphate react during 5 hours at 75° C. to prepare a graft copolymer (g-ABS) latex. 0.4 parts by weight of sulfuric acid is added into the resultant product, and the resultant product is coagulated to prepare a graft copolymer resin (g-ABS) in the form of powder with a polybutadiene (PBD) size of 2800 (10⁻¹⁰m), PBD amount of 58% by weight and a degree of grafting of 89%.

[Reference 1] Method for Measuring Degree of Grafting

Isopropyl alcohol (IPA) is boiled in a water base. 20 to 25 mL of a sample of the graft copolymer resin are added into a 100 mL beaker, 70 mL of the boiled IPA is added into the beaker and the mixture is stirred. If particles are not formed, 10% sulfuric acid is added in an amount of 5 drops by means of pipette. After stirring the mixture is solidified in water base (when stirring the mixture is stirred with a spoon about twice so as not to agglomerate). Before filtering, methanol is added into the mixture and the mixture is left for 5 to 10 minutes (in the case of MBS, the particle is not captured, but after methanol is added and the time has passed, particle can be captured). After the time has passed, the mixture is filtered (agglomerated parts are most crushed). The filtered sample is placed into 80° C. vacuum oven, and the sample is dried for 1 hour 30 minutes. After drying, the sample is cooled to room temperature for 30 minutes. 1.2 g (when measuring viscosity, 2.0 g) of the sample and appropriate amount of acetone are added into 250 ml reflux flask. The sample is shot with ultrasonic wave from an ultrasonic device until the particles are dissolved. The separated sample is rotated (reflux) in water base (when rotating, temperature is set to about 60 to 70° C.). Sample number is written on PE-TUBE, and PE-TUBE is weighed. The sample after reflux is added into PE-TUBE, while PE-TUBE is cleaned with acetone. The sample is inserted into a centrifugal separator, and the sample is turned at the rate of 20,000 RPM for 1 hour. When the viscosity exists, the supernatant liquid of the sample after centrifugation is complete is transferred to the prepared foil cup, and the PE-TUBE is dried in 105° C. oven during 2 hours. The foil cup comprising only the supernatant liquid is placed on water base that is boiled at 100° C., and the supernatant liquid is rotated (reflux) until the liquid is changed to the solid. The captured FEER-SAN is dried in 105° C. oven during 1 hour. The dried PE-TUBE is removed from the oven, is dried at room temperature for 30 minutes, and is weighed.

[Reference 2] Method for Measuring Amount of Polybutadiene (PBD) (%)

For a pellet

The sample is added into a 50 ml brown round flask, and is weighed (up to four-digit under decimal point). 25 to 30 ml of chloroform is added into the flask. The flask is shaken until the sample is fully dissolved. 10 ml of IC1-CCl₄ is added into the flask, and chloroform is added into the flask up to marking line. For Blank Test, the sample in which IC1-CCl₄ and chloroform only are added into the flask is prepared. The sample is left in a cool and dark location for 30 minutes, and 20 ml of the sample is added into the titration beaker with 60 ml of KI solution. It is titrated by standard solution of 0.04N—Na₂S₂O₃ (Starch 1 to 2 ml).

Calculation: (Blank consuming CC−Sample consuming CC)×6.7625×Standard solution F×2=Weight of Sample

For a powder

For a powder, because amount of PBD is almost about 50%, the sample is sifted with 80 mesh of sifter, 0.1 g of the sample is added into a 100 ml brown round flask, is weighed, and chloroform is added into the flask up to half full. The sample is left in an ultrasonic device for 1 hour and 10 minute. 20 ml of IC1-CCl₄ is added into the flask, chloroform is added into the flask up to marking line, and the sample is left in a cool and dark location for 30 minutes. Method for titrating is the same as for the pellet. Sample amount of titration is 20 ml.

Calculation: (Blank consuming CC−Sample consuming CC)×6.7625×Standard solution F×2=Weight of Sample

(A2) Copolymer Resin

75 parts by weight of styrene, 25 parts by weight of acrylonitrile, 120 parts by weight of deionized water, 0.2 parts by weight of azobisisobutylonitrile, 0.4 parts by weight of tricalcium phosphate and 0.2 part by weight of mercaptan-based chain-transfer agent are added into the reactor, temperature is increased from room temperature to 80° C. for 90 minutes, and temperature is maintained at 80° C. for 180 minutes to prepare styrene-acrylonitrile copolymer resin (SAN). The resultant product is washed, dewatered and dried to prepare styrene-acrylonitrile copolymer resin (SAN) in the form of powder with weight average molecular weight of 113,000 to 250,000 g/mol.

(B) Matting Agent

A polystyrene (PS)/styrene-acrylonitrile (SAN) copolymer made by GE SPECIALTY CHEMICAL Company (product name: BLENDEX BMAT) is used.

(C) Brominated Flame Retardant

Brominated epoxy oligomer with bromine amount of 50 to 52% made by KUKDO Chemical Company (product name: VDB-406) is used.

(D) Flame Retardant Aid

Antimony trioxide made by IL SUNG ANTIMONY Company (product name: ANTIS-W) is used.

### Examples 1 to 6 and Comparative Examples 1 to 3

The above components in amounts shown in Table 1 are added and uniformly mixed in a Henschel mixer for 3 to 10 minutes. The mixture is extruded by a conventional twin screw extruder at an extruding temperature of 180 to 210° C., a screw rotation speed of 150 to 300 rpm, and a feed rate of the composition of 30 to 60 kg/hr to prepare pellets. The prepared pellets are dried at 100° C. for 4 hours, and injection-molded using a 6 oz injection machine at a molding temperature of 180 to 210° C. and a mold temperature of 40 to 80° C. to prepare a specimen.

TABLE 1

| | (A1) | (A2) | (B) | (C) | (D) | |
|---|---|---|---|---|---|---|
| | Amount | Amount | Amount | Amount | Amount | |
| | (% by | (% by | (parts by | (parts by | (parts by | |
| Classification | weight) | weight) | weight) | weight) | weight) | Remarks |
| Example 1 | 25 | 75 | 2 | 21 | 5.5 | Additive: |
| Example 2 | 25 | 75 | 4 | 21 | 5.5 | primary |
| Example 3 | 25 | 75 | 6 | 21 | 5.5 | antioxidant, |
| Example 4 | 30 | 70 | 2 | 21 | 5.5 | secondary |
| Example 5 | 30 | 70 | 4 | 21 | 5.5 | antioxidant |
| Example 6 | 30 | 70 | 6 | 21 | 5.5 | and lubricant |
| Comparative Example 1 | 20 | 80 | — | 21 | 5.5 | are used in |
| Comparative Example 2 | 35 | 65 | — | 21 | 5.5 | same amount |
| Comparative Example 3 | 30 | 70 | 15 | 21 | 5.5 | |

Methods for Measuring Properties

Properties of the resin compositions prepared by the above method are measured by the following methods, and the results thereof are set forth in Table 2.

(1) Impact Resistance: notch izod impact strength (kgf·cm/cm) of a specimen with thickness of ⅛ inch (3.175 mm) is measured in accordance with ASTM D256.

(2) Flowability: melt flow index (g/10 min) is measured in accordance with ASTM D1238 under the conditions of a temperature of 200° C. and a load of 5 kg.

(3) Flame Retardancy: flame retardant level of a specimen with a thickness of 2.5 mm is measured in accordance with the UL94 flame retardant standard.

(4) Gloss property: the degree of gloss of a specimen, which is prepared by injection-molding the flame retardant thermoplastic resin composition by means of color chip G30 face (for measuring gloss) injection machine, is measured in accordance with ASTM D523 in a vertical (long axis) direction at 60 degrees.

TABLE 2

| | IZOD Impact | Melt Flow | | |
|---|---|---|---|---|
| | Strength | Index | UL94 Flame | Gloss |
| Classification | (kgf · cm/cm) | (g/10 min) | Retardant Level | Degree |
| Example 1 | 11.5 | 2.4 | V0 | 24 |
| Example 2 | 12.1 | 2.5 | V0 | 16 |
| Example 3 | 11.8 | 2.4 | V0 | 19 |
| Example 4 | 18.5 | 2.8 | V0 | 23 |
| Example 5 | 17.4 | 2.7 | V0 | 17 |
| Example 6 | 17.6 | 2.4 | V0 | 20 |
| Comparative | 7.5 | 3.8 | V0 | 87 |
| Example 1 | | | | |
| Comparative | 28.0 | 2.1 | V2 | 85 |
| Example 2 | | | | |
| Comparative | 17.5 | 2.5 | V2 | 25 |
| Example 3 | | | | |

As shown in Table 2, examples 1-6 comprise appropriate amounts of g-ABS, SAN, brominated flame retardant, flame retardant aid and matting agent, and thereby show excellent impact strength, flame retardancy and low-gloss property. However, Comparative Examples 1-2 do not comprise the matting agent, and thus have a high degree of gloss. Comparative Example 3 comprises the matting agent in an amount of 15 parts by weight, which is greater than the amount of the invention; impact resistance and flowability do not change, but flame retardancy deteriorates. In Comparative Example 2, which includes g-ABS resin in an amount of 35 parts by weight, because the amount of rubber is higher than that of examples 1-6, impact resistance increases, but flame retardancy deteriorates. The examples demonstrate that compositions including an appropriate amount of g-ABS, SAN, matting agent and brominated flame retardant, can exhibit both excellent impact resistance and low-gloss property.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. A flame retardant thermoplastic resin composition comprising:
(A) about 100 parts by weight of rubber modified aromatic vinyl copolymer resin;
(B) about 0.1 parts by weight to about 10 parts by weight of a matting agent, based on about 100 parts by weight of the rubber modified aromatic vinyl copolymer resin (A); and
(C) about 19 parts by weight to about 23 parts by weight of a brominated flame retardant, based on about 100 parts by weight of the rubber modified aromatic vinyl copolymer resin (A).

2. The flame retardant thermoplastic resin composition of claim 1, wherein the rubber modified aromatic vinyl copolymer resin (A) comprises (A1) about 21% by weight to about 34% by weight of a graft copolymer resin prepared by graft-copolymerizing rubbery polymer, aromatic vinyl monomer, monomer copolymerizable with aromatic vinyl monomer and optionally monomer imparting processability and heat resistance, and (A2) about 66% by weight to about 79% by weight of a copolymer resin prepared by copolymerizing aromatic vinyl monomer, monomer copolymerizable with aromatic vinyl monomer and optionally monomer imparting processability and heat resistance.

3. The flame retardant thermoplastic resin composition of claim 2, wherein the graft copolymer (A1) is prepared by graft-copolymerizing about 34% by weight to about 94% by weight of the aromatic vinyl monomer, about 1% by weight to about 30% by weight of the monomer copolymerizable with aromatic vinyl monomer and about 0% by weight to about 15% by weight of the monomer imparting processability and heat resistance onto about 5% by weight to about 65% by weight of the rubbery polymer.

4. The flame retardant thermoplastic resin composition of claim 2, wherein the copolymer resin (A2) is prepared by copolymerzing about 60% by weight to about 90% by weight of the aromatic vinyl monomer, about 10% by weight to about 40% by weight of the monomer copolymerizable with aromatic vinyl monomer and about 0% by weight to about 30% by weight of the monomer imparting processability and heat resistance.

5. The flame retardant thermoplastic resin composition of claim 1, wherein the matting agent (B) has weight average molecular weight of about 1,000,000 g/mol to about 10,000,000 g/mol.

6. The flame retardant thermoplastic resin composition of claim 1, wherein the matting agent (B) comprises a mixture of polystyrene and acrylonitrile-styrene copolymer.

7. The flame retardant thermoplastic resin composition of claim 1, wherein the brominated flame retardant (C) comprises brominated epoxy oligomer.

8. The flame retardant thermoplastic resin composition of claim 1, further comprising antimony oxide as a flame retardant aid.

9. The flame retardant thermoplastic resin composition of claim 1, further comprising one or more additives selected from the group consisting of plasticizers, anti-dripping agents, heat stabilizers, release agents, weather-proof stabilizers, halogen stabilizers, lubricants, fillers, coupling agents, light stabilizers, antioxidants, coloring agents, anti-static agents, dispersing agents, impact modifiers, and combinations thereof.

10. The flame retardant thermoplastic resin composition of claim 1, wherein a specimen with a thickness of 3.175 mm formed of the flame retardant thermoplastic resin composition has a notch izod impact strength measured in accordance with ASTM D256 of about 10 kgf·cm/cm to about 20 kgf·cm/cm.

11. The flame retardant thermoplastic resin composition of claim 1, having a melt flow index measured in accordance with ASTM D1238 under the conditions of a temperature of 200° C. and a load of 5 kg of about 2.3 g/10 min to about 3.0 g/10 min.

12. The flame retardant thermoplastic resin composition of claim 1, wherein a specimen with a thickness of 2.5 mm formed of the flame retardant thermoplastic resin composition has a flame retardant level measured in accordance with UL94 of V0.

13. The flame retardant thermoplastic resin composition of claim 1, wherein a specimen prepared by injection-molding the flame retardant thermoplastic resin composition with a color chip G30 face injection machine has a degree of gloss measured in accordance with ASTM D523 in a vertical direction at 60 degrees of about 10 to about 25.
